(19) United States
(12) Patent Application Publication
(10) Pub. No.: US 2002/0100789 A1
(43) Pub. Date: Aug. 1, 2002

(54) Hand held nail guiding and driving apparatus

(76) Inventor: Robert C. Schrank, San Juan Capistrano, CA (US)

Correspondence Address: Edward E. Roberts, P.O. Box 3206, Dana Point, CA, 92629, US

(21) Appl. No.: 10/072,336

(22) Filed: Feb. 11, 2002

Related U.S. Application Data
(60) Provisional application No. 60/265,027, filed on Jan. 31, 2001.

(51) Int. Cl. B25C 7/00

(52) U.S. Cl. 227/147

(57) ABSTRACT

Hand held nail guiding and driving apparatus for securing wooden flooring to floor joists to eliminate creaking without having to pull back carpeting or otherwise expose the flooring The apparatus has a driving punch slidably disposed within a hollow guide tube that has a handle portion for manual insertion of said guide tube through the carpet and padding to a selected flooring location. The driving punch includes a nail-driving portion for insertion into the guide tube in proximity to a previously inserted nail, and an enlarged external head portion for receiving nail driving blows. The handle portion has the hollow nail guide tube extending completely therethrough for slidably receiving the nail and nail driving punch through the top thereof The guide tube extends a given distance from the bottom of the handle to terminate with an angle cut to facilitate setting of the nail at an angle to decrease the likelihood that the nail will work itself out. The angle cut also facilitates penetration of the carpet and padding material. The nail is inserted through the guide tube at the top of the handle and a first portion of the nail driving punch is inserted into the guide tube and into contact with the nail. Driving means such as a hammer is used to pound the external enlarged head portion of the driving punch to drive the nail into place. Additional nails are set at angle, in wedge-like manner, as required to secure the wooden flooring to appropriate floor joists to thereby eliminate creaking without having to remove the carpet and padding.

CLAIM FOR BENEFIT OF EARLIER FILING DATE

This application claims the benefit of U.S. Provisional Application No. 60/265027 filed on Jan. 31, 2001 and entitled “STOP CREAK”. This application has the same inventor and subject matter as, but a different title from, said provisional application.

### BACKGROUND OF THE INVENTION

The background of the invention will be discussed in two parts:

1. Field of the Invention

This invention relates generally to apparatus or tools, for driving nails, and particularly to a hand held nail guiding device for positioning, starting, driving and setting nails for securing wooden flooring to floor joists in areas where creaking occurs without having to lift or remove the carpet.

2. Description of the Prior Art

In the act of positioning, starting, driving and setting nails it is generally required that the nail be precisely positioned and securely held in place while being driven into the selected position. In many situations this is difficult and time consuming when attempted by hand, thus various nail-driving tools have been developed and used in the prior art. Such devices commonly utilize some form of nail guiding apparatus for positioning and driving the nails into the desired locations

One such prior art device is shown and described in U.S. Pat. No. 3,147,484 issued to Nelson on Sep. 8, 1964, wherein there is disclosed apparatus designed to position and drive a nail angularly into a work piece. The device utilizes a plunger having a driving head that is slidably disposed within a cylindrical guide.

Another such prior art device is shown and described in U.S. Pat. No. 4,676,424 issued to Meador, et al. on Jun. 30, 1987 wherein apparatus is disclosed for positioning and setting nails into hard to reach places. Included is a punch slidably disposed within a hollow sleeve

Yet another such prior art device is shown and described in U.S. Pat. No. 4,838,471 issued to Chiesa on Jun. 13, 1989. The device of Chiesa discloses apparatus for positioning and setting nails that includes a hollow cylindrical barrel having a stepped diameter longitudinal bore for holding the nail.

In light of the above, and other known prior art, hand held apparatus is needed for selected positioning and guided starting, driving and setting nails for securing wooden flooring to floor joists in areas where creaking occurs without having to remove the carpet.

It is thus an aspect of the invention to provide a novel nail guiding and driving tool

It is another aspect of the invention to provide a hand held tool that is utilized for guided starting, driving and setting of a nail without requirement of manual manipulation during the procedure

It is yet another aspect of the invention to provide a hand held guiding and driving tool for securing wooden flooring to supporting floor joists to thereby eliminate creaking.

It is still another aspect of the invention to provide a hand held guiding and driving tool for setting opposing nails in wedge-like manner to better secure wooden flooring to supporting floor joists to thereby eliminate creaking.

It is a further object of our invention to provide a simple manually operated nail guiding and driving tool that is particularly adapted to driving nails through carpet and padding and into floor joists without lifting or removal of the carpet and padding.

### SUMMARY OF THE INVENTION

In accordance with the invention, there is provided hand held nail-guiding apparatus adapted for positioning, starting, driving and setting nails for securing wooden flooring to floor joists, in areas where creaking occurs, without having to lift or remove the carpet.

The invention is consists basically of a nail punch and a hollow guide tube for the punch The punch has an elongated nail-driving portion for insertion into the guide tube and an enlarged external head portion for receiving nail-driving blows. The guide tube is open at both ends with an inside diameter suitable for accepting the nail punch therethrough as well as the nail to be set.

At one end the guide tube has a fixedly attached handle substantially flush with the end of the tube but open for receiving in sequence the nail and the driving punch. The remainder of the punch extends a given distance from the bottom of the handle to terminate with an angle cut of approximately 15 degrees. The angle cut is primarily to facilitate setting of opposing nails in wedge-like manner; however, it also facilitates penetration of carpet and padding material The guide tube is inserted at angle to provide the nail is likewise inserted to thus provide less likelihood that the nail will work itself out.

In operation, the handle portion is first used to manually force the guide tube at an angle through the carpet, and any padding material onto the flooring at a previously determined floor joist location. The guide tube is held in contact with the flooring at the approximately 15 degree angle, the nail is inserted through the guide tube at the top of the handle followed by the punch, and driving means such as a hammer is then used to pound the nail into place. Typically, two nails are driven at opposing angles in wedge-like manner at each location

Additional nails are likewise positioned as required to secure the wooden flooring to appropriate floor joists to thereby eliminate creaking without having to remove the carpet and padding. Nails used are commercially available finishing nails. The nails are commercially available finishing nails.

The foregoing and other aspects, objects, features and advantages of our invention will become apparent to those skilled in the art from the reading of the following description taken in conjunction with the drawings, wherein like reference numerals refer to like elements in the several views.

### DESCRIPTION OF THE DRAWINGS

FIG. 1 is an exploded view of the nail guiding and driving apparatus in accordance with the invention;

FIG. 2 is a perspective view of the nail guiding and driving apparatus showing method of use in accordance with the invention;

FIG. 3 is a cross-sectional view of the invention as shown in the exploded view of FIG. 1 taken along the centerline thereof, and

FIG. 4 is a cross-sectional view of the invention as shown in the exploded view of FIG. 3 with the nail driving punch inserted within the guide tube.

### DESCRIPTION OF THE PREFERRED EMBODIMENT

Referring now to the drawings in general, there is shown hand held nail-guiding apparatus, generally designated 10, for securing wooden flooring to floor joists to eliminate creaking without having to pull back the carpet and padding, or otherwise expose the flooring

FIG. 1 shows nail guiding apparatus 10 comprised of a driving punch, generally designated 11, and a guide tube 12. Guide tube 12 is hollow and has an affixed handle portion 13 at one end with the tube 12 extending a given distance from the bottom of the handle and terminating with angle cut 12a. Angle cut 12a is of generally selected at approximately 15 degrees and provides for setting nails at an angle into flooring 16 as will be discussed further hereinafter.

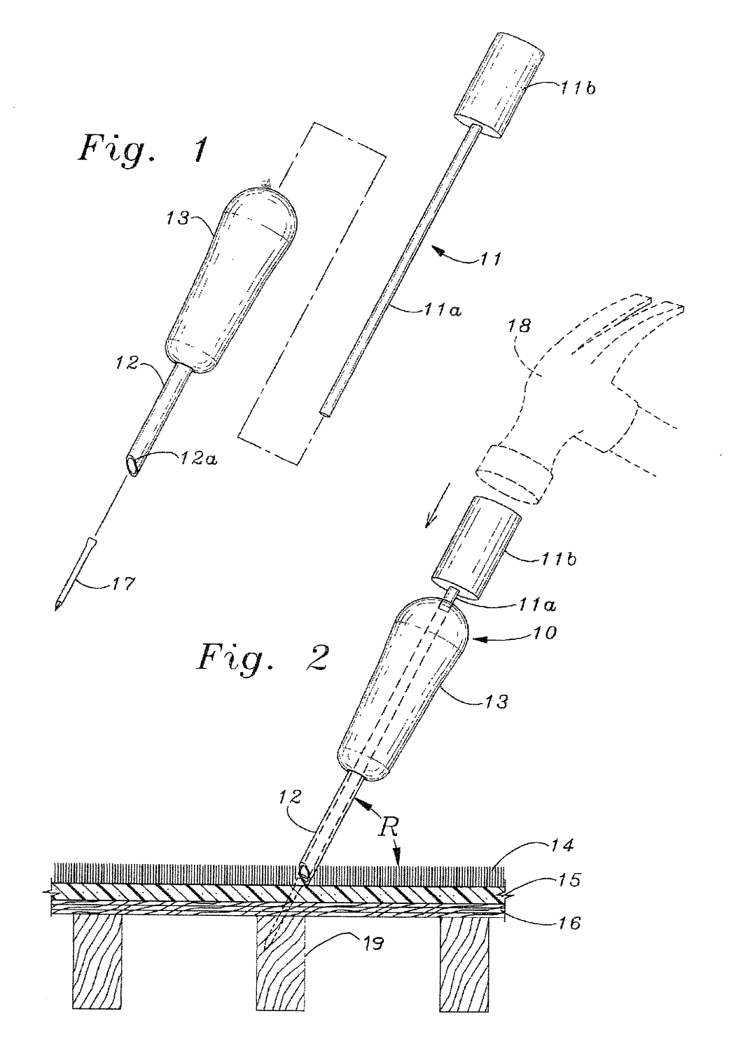

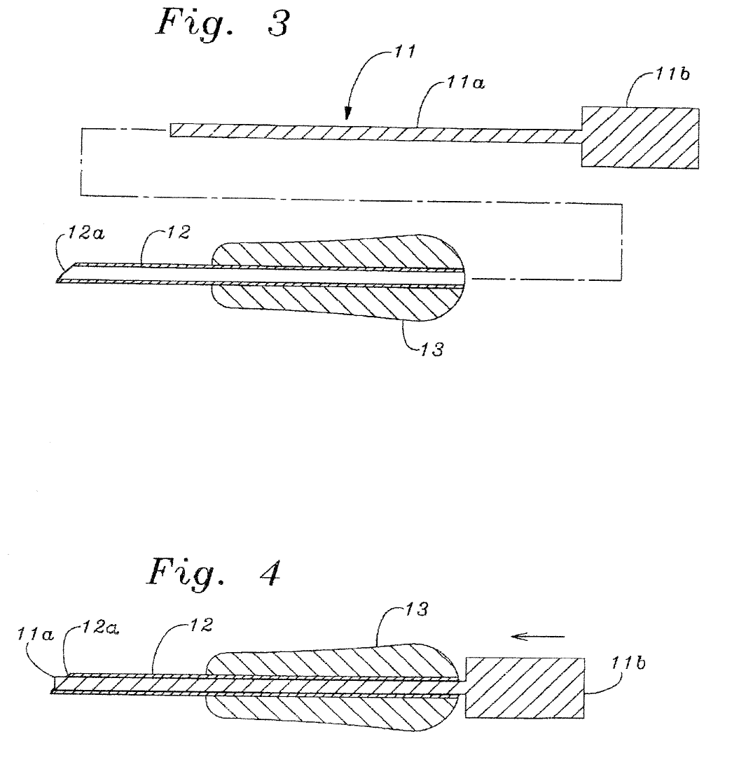

Driving punch 11 includes punch portion 11a to be slidably disposed through handle 13 and hollow guide tube 12, and an enlarged external head portion 11b for receiving nail driving blows as indicated by the arrow in FIG. 2. As indicated by the arrow in FIG. 4, guide tube 12 provides access throughout its length of the combination tube and handle for punch portion 11a Handle 13 provides for easier manual insertion of guide tube 12 through the carpet 14 and padding 15 and to a selected location on flooring 16.

The angle cut 12a is primarily to facilitate placement of the nail guide 12 in proximity to flooring 16 to facilitate driving of nail 17 at selected angle R into flooring 16. That is, when guide tube 12 is held either with the cut 12a in contact with, or substantially in parallel proximity to flooring 16, the angle of insertion of the nail 17 into flooring 16 is also approximately 15 degrees. Insertion of the nail 17 at an angle decreases the likelihood that the nail will work out of the joist 19 over time. Angle cut 12a is selected at approximately 15 degrees, although other angles would be adequate in practicing the invention.

Typically, two nails are driven at opposing angles in wedge-like manner at each location to thus provide less likelihood that the nails will work themselves out. Nails driven straight into the flooring will tend to work out under conditions of expansion and contraction of the wood. It is to be understood that in practice of the invention an angle cut is not necessary and/or other angles may be selected if desired. However, for best results it is important that the nails be set at an angle adequate to minimize the effects of normal expansion and contraction of the wood The nail 17 is inserted through guide tube 12 at the top of the handle portion 13 and nail-driving portion 11a is inserted into guide tube 12 and in proximity to nail 17. As generally indicated by the arrow in FIG. 4, driving means such as hammer 18, shown in phantom, is used to pound the enlarged head portion 11b of driving punch 11 to drive the nail 17 into selected flooring locations. As discussed, nail 17 is driven at an angle into flooring 16 and into an appropriate floor joist, such as joist 19, to thereby better secure the flooring 16 to appropriate floor joists 19. Nail 17 can be a commercially available finishing nail.

Thus, a desired number of nails 17 are inserted through the flooring 16 into the floor joists 19 in close proximity to each other at a particular selected floor locations. The nails 17 are driven at the desired angle, typically 15 degrees, to the flooring 16 generally pointing in opposite directions to act like wedges. Additional nails are likewise positioned through the flooring to other appropriate floor joists as required to eliminate creaking Proper use of the invention enables the nails to be driven through carpet and padding without damaging the carpet or leaving a trace of the inserted nails.

As an example, guide tube 12 is metallic, typically of brass or steel and generally measuring approximately ¼ inch in outer diameter and about 3 inches in length The inside diameter is large enough to slidably accept punch 11 and a finishing nail, such as an 8d nail As mentioned, guide tube 12 has an angle cut 12a of approximately 15 degrees at the penetration end thereof Tube guide 12 can be made from commercially available brass or stainless steel stock using conventional cutting and machining processes

Handle portion 13, which surrounds the upper portion of guide tube 12 is generally cylindrical or bulb-shaped and would measure roughly an inch in diameter and 1½ inches long. The handle 13 is generally made of plastic molded around guide tube 12 However, it can be cut and machined from purchased wood stock that is then stained, varnished and secured to the guide tube with appropriate adhesive.

In operation, the handle portion 13 is first used to manually force the guide tube 12 at the selected angle through the carpet 14 and padding material 15, and onto the flooring 16 at the previously determined floor joist location. The angle cut 12a facilitates penetration of the carpet and any padding material, however as explained, its primarily purpose is to facilitate placement of the nail guide 12 in proximity to the flooring 16 to facilitate driving of nail 17 at a selected angle into the flooring. Guide tube 12 is then held in contact, or in adequate proximity, with the flooring 16 at the desired location. Nail 17, followed by the punch portion 11a, is inserted through guide tube 12 at the top of the handle 13, and then driving means such as hammer 18 is used to pound the nail 17 into place. An adequate number of nails are driven at angle, in wedge-like manner, through the flooring and into the selected joist at opposing angles at each location

There has been shown and described a simple manually operated nail guiding and driving tool that is particularly adapted to driving nails through carpet and padding and into floor joists without removal or lifting of the carpet and padding. However, the invention can be used as punch apparatus for various requirements Thus, although the invention has been described with respect to specific details of a preferred embodiment thereof, it is not intended that such details limit the scope and coverage of the invention other than as specifically set forth in the following claims.

What is claimed is:

1. Nail guiding and driving apparatus for driving a nail through carpet, padding and wooden flooring for securing wooden flooring to an underlying floor joist, comprising:
a hollow nail guide tube having open ends for slidably receiving said nail;
a nail driving punch having a portion for slidably insertion within said guide tube,
a handle formed on a first end of said guide tube; said guide tube extending a given distance from the bottom of said handle for receiving said nail and said driving punch.

2. The apparatus of claim 1 wherein said guide tube terminates at said given distance with an angle cut to facilitate insertion of said nail at said angle into said floor joist.

3. The apparatus of claim 1 wherein said guide tube terminates at said given distance with an angle cut to facilitate penetration of said carpet and padding material

4. The apparatus of claim 2 wherein said handle is configured for facilitating manual insertion of said other end of said guide tube through said carpet and padding and against said flooring.

5. The apparatus of claim 1 further including driving means for a hammer for impacting said driving punch to thereby force said nail into said flooring.

6. The nail guiding and driving apparatus of claim 4 wherein said handle substantially surrounds said guide tube at the other end thereof and is generally bulb-shaped.

7. The nail guiding and driving apparatus of claim 2 wherein said guide tube is generally cylindrically shaped and of substantially uniform inside diameter throughout its entire length.

8. Nail guiding and driving apparatus comprising.
a hollow guide tube having open ends, said tube configured for accepting a nail therethrough;
a handle affixed at one end of said tube, said tube extending a selected distance from the bottom of said handle; and
nail-driving means having a portion for slidably insertion into said guide tube from the top of said handle for driving said nail from the other end of said guide tube

9. The nail guiding and driving apparatus of claim 8 wherein said other end is terminated at an angle to facilitate insertion of said nail into a working material at said angle.

10. The nail guiding and driving apparatus of claim 8 wherein said other end is terminated at an angle cut to facilitate insertion of said guide tube into a working material

11. The nail guiding and driving apparatus of claim 9 wherein said nail driving means has a nail driving portion closely conforming to but freely slidable within said guide tube, and a head portion having a diameter larger that the inside diameter of said guide tube to thereby limit tube guide access and for receiving nail driving blows.

12. The nail guiding and driving apparatus of claim 11 wherein said guide tube is generally cylindrically shaped and of substantially uniform inside diameter throughout its entire length.

13. The nail guiding and driving apparatus of claim 12 wherein said handle substantially surrounds said guide tube at the other end thereof and is generally bulb-shaped

14. The nail guiding and driving apparatus of claim 2 wherein said handle is configured for manual insertion of a portion of said guide tube into said working material.

15. Nail guiding and driving apparatus for driving a nail through carpet, padding and wooden flooring for securing said flooring to an underlying floor joist, comprising:
a hollow nail guide tube having open ends for slidably receiving said nail,
a nail driving punch having a portion for slidably insertion within one end of said guide tube, the other end of said guide tube terminated at an angle cut to facilitate insertion of said nail into said joist substantially at said angle.

16. The nail guiding and driving apparatus of claim 15 further including a handle formed on said first end of said guide tube; said guide tube extending a given distance from the bottom of said handle for receiving said nail and said driving punch.

17. The apparatus of claim 16 further including driving means for a hammer for impacting said driving punch to thereby force said nail into said flooring.
